(19) United States
(12) Patent Application Publication
(10) Pub. No.: US 2007/0024584 A1
(43) Pub. Date: Feb. 1, 2007

(54) System and method for fault detection and recovery for an optical input area

(76) Inventors: Chee-Heng Wong, Singapore (SG); Kok-Keong Teo, Singapore (SG); Kai-Koon Lee, Singapore (SG)

Correspondence Address: AVAGO TECHNOLOGIES, LTD., P.O. BOX 1920, DENVER, CO, 80201-1920, US

(21) Appl. No.: 11/195,249

(22) Filed: Aug. 1, 2005

(51) Int. Cl. G09G 5/08

(52) U.S. Cl. 345/158

(57) ABSTRACT

A system is disclosed for providing input to a computer, the system comprising an optical input area; a controller device; a diagnostic mode for assigning a status of faulty pathway to interrupted pathways; and a normal function mode for excluding interrupted pathways and determining a pair of minimum and maximum coordinates formed at intersections of a first pair and a second pair of outermost interrupted pathways. A method for providing input to a computer is disclosed, the method comprising providing an optical input area and a controller; selecting the diagnostic mode; assigning a status of faulty pathway to interrupted pathways; selecting the normal function mode; excluding interrupted pathways; determining a pair of minimum and maximum coordinates formed at intersections of a first pair of outermost interrupted pathways and a second pair of outermost interrupted pathways; and reporting the pair of minimum and maximum coordinates to the computer.

### BACKGROUND

Computers may receive input in a variety of ways, including, by means of a keyboard, or computer input area. Computer input areas generally include one or two forms, i.e., that of a touch pad comprising discrete sensors (e.g., a touch pad comprising an array of capacitive sensors), or that of a touch pad or other perimeter sensor comprising sets of intersecting detection paths (e.g., a touch pad comprising first and second sets of intersecting sets of optical detection paths).

Optical infrared touch panel generally provide up to 100% transparency and generally require no touch force, which are desirable properties for many LCD applications. An optical touch panel generally operates by using many pairs of emitters and detectors.

Emitter and detector pairs may become non-functional for various reasons. One example is dirt or dust particles that block the emitter or the detector. Another example is the end of service life for either the emitter or the detector. Such non-functional emitters and detectors may cause erroneous computer input.

For many other touch panel technologies, including resistive and capacitive sensors, a faulty portion on the touch panel generally causes the whole panel to stop functioning.

### SUMMARY OF THE INVENTION

In one embodiment, there is provided a system for providing input to a computer, the system comprising an optical input area having a first set of optical detection pathways and a second set of optical detection pathways, and the first set of optical detection pathways and the second set of optical detection pathways positioned at an angle with respect to one another so as to provide a plurality of intersecting locations; a controller device in communication with the optical touch screen and the computer, the controller having a diagnostic function mode and a normal mode, the controller device receiving indications of interrupted pathways from optical input area corresponding to interrupted pathways of the first set of optical detection pathways and interrupted pathways of the second set of optical pathways; the diagnostic mode of the controller having code for assigning a status of faulty pathway to each one of the interrupted pathways of the first set of optical detection pathways and to each one of the interrupted pathways of the second set of optical detection pathways; and the normal function mode of the controller having code for excluding each one of the interrupted pathways having the status of faulty pathway and determining a first pair of outermost interrupted pathways of the first set of optical detection pathways, a second pair of outermost interrupted pathways of the second set of optical detection pathways, and a pair of minimum and maximum coordinates formed at intersections of the first pair of outermost interrupted pathways and the second pair of outermost interrupted pathways, wherein the pair of minimum and maximum coordinates correspond to a blocked area formed on the touch screen.

In another embodiment, there is provided a method for providing input to a computer, the method comprising providing a system for providing input to the computer, the system comprising an optical input area having a first set of optical detection pathways and a second set of optical detection pathways, the first set of optical detection pathways and the second set of optical detection pathways positioned at an angle with respect to one another so as to provide a plurality of intersecting locations; and a controller device in communication with the optical input area and the computer, the controller having a diagnostic function mode and a normal mode, and the controller device receiving indications of interrupted pathways from optical input area corresponding to interrupted pathways of the first set of optical detection pathways and interrupted pathways of the second set of optical pathways; selecting the diagnostic mode of the controller, and then assigning a status of faulty pathway to each one of the interrupted pathways of the first set of optical detection pathways and to each one of the interrupted pathways of the second set of optical detection pathways; selecting the normal function mode of the controller, and then (i) excluding each one of the interrupted pathways having the status of faulty pathway; (ii) determining a first pair of outermost interrupted pathways of the first set of optical detection pathways and a second pair of outermost interrupted pathways of the second set of optical detection pathways; (iii) determining a pair of minimum and maximum coordinates formed at intersections of the first pair of outermost interrupted pathways and the second pair of outermost interrupted pathways; and (iv) reporting the pair of minimum and maximum coordinates to the computer, wherein the pair of minimum and maximum coordinates correspond to a blocked area formed on the optical input area.

Other embodiments are also disclosed.

### BRIEF DESCRIPTION OF THE DRAWINGS

Illustrative embodiments of the invention are illustrated in the drawings, in which:

FIG. 1 illustrates an optical touch screen having optical detection pathways of emitter and receiver pairs, three pairs of faulty pathways of emitter and receiver pairs, and a blocked area formed on the optical touch screen;

FIG. 2 illustrates coordinates being incorrectly reported due to the faulty pathways of the emitter and receiver pairs of the optical detection pathways;

FIG. 3 illustrates coordinates being correctly reported with the faulty pathways disabled so as to exclude the faulty pathways from the determination of coordinates corresponding to the blocked area formed on the touch screen;

FIG. 4 illustrates a faulty pathway detected on optical detection pathway X4;

FIG. 5 illustrates coordinates being incorrectly reported due to the faulty pathways of the faulty pathway at optical detection pathway X4;

FIG. 6 illustrates coordinates being correctly reported with the faulty pathway disabled so as to exclude the optical detection pathway X4 from the determination of coordinates corresponding to the blocked area formed on the touch screen;

FIG. 7 is a flow chart diagram of an embodiment of a method for providing input to a computer; and

FIG. 8 is a flow chart diagram of an embodiment of a method for providing input to a computer.

### DETAILED DESCRIPTION

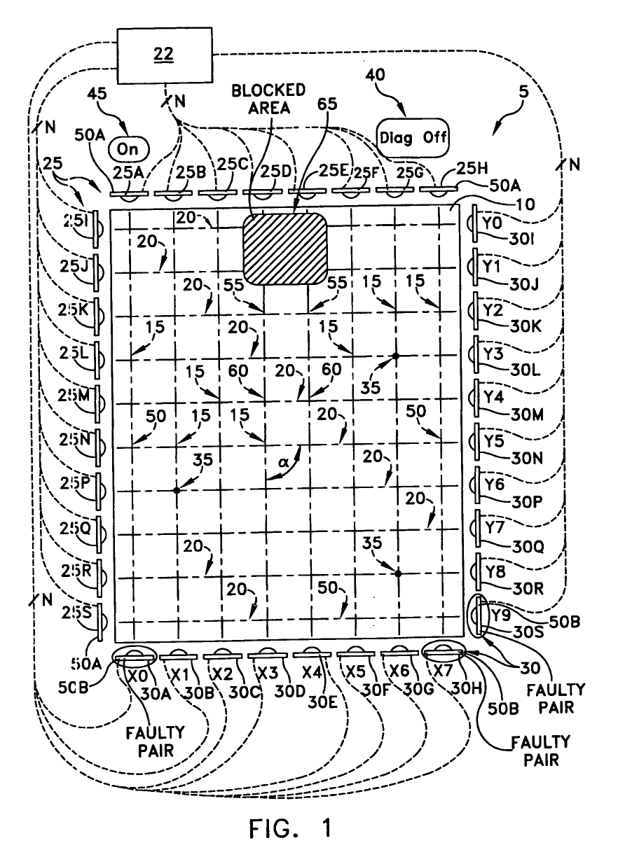

Referring to FIGS. 1-6, and in an embodiment, there is shown a system 5 for providing input to a computer. System 5 may include an optical input area 10 having a first set of optical detection pathways 15 and a second set of optical detection pathways 20. Optical emitters 25A-25H and optical detectors 30A-30H may form the first set of optical detection pathways 15, and optical emitters 25I-25S and optical detectors 30I-30S may form the second set of optical pathways 20.

In one embodiment, optical input area 10 may comprise an optical touch screen. In another embodiment, optical input area 10 may comprise an input pad, which may include markings or may be a blank background. In still another embodiment, optical input area 10 may include an opening, without a screen or pad, formed between optical emitters 25A-25H and optical detectors 30A-30H.

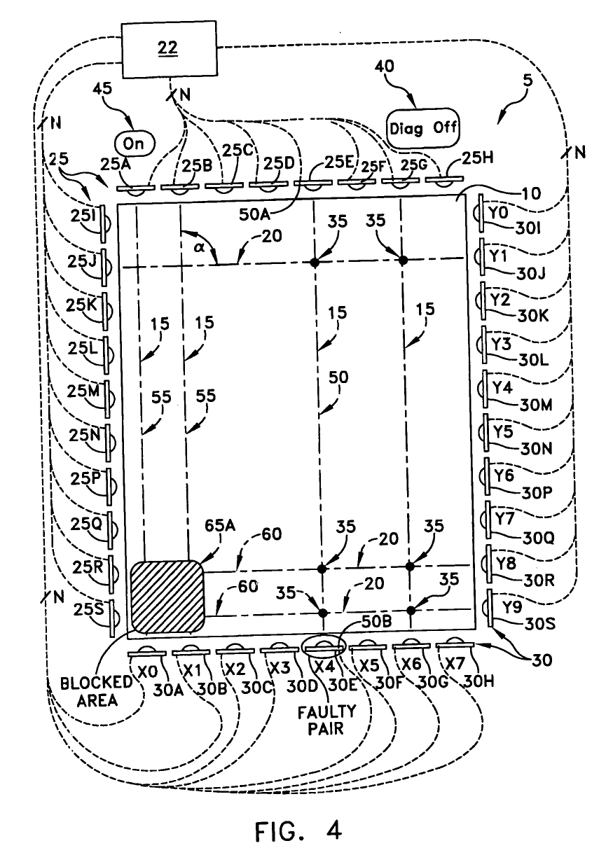

First set of optical detection pathways 15 and second set of optical detection pathways 20 are positioned at an angle α with respect to one another (FIGS. 1 and 4) so as to provide a plurality of intersecting locations 35, which may be represented by a set of coordinates 35AI-35HS formed at intersecting locations 35 of the first set of optical detection pathways 15 and the second set of optical detection pathways 20.

In an embodiment, a controller device 22 may be in communication with optical input area 10 and the computer. A diagnostic function mode, which may be represented by diagnostic function indicator 40, and a normal mode, which may be represented by normal function indicator 45, are selectively actuated by controller device 22. Controller device 22 may receive indications of interrupted pathways from optical input area 10 corresponding to interrupted pathways of the first set of optical detection pathways 15 and interrupted pathways of the second set of optical pathways 20. The diagnostic mode of controller device 22 may have code for assigning a status of faulty pathway 50 to each one of the interrupted pathways of the first set of optical detection pathways 15 and to each one of the interrupted pathways of the second set of optical detection pathways 20.

In an embodiment, the normal function mode of controller device 22 has code for excluding each one of the interrupted pathways having the status of faulty pathway 50 and determining a first pair of outermost interrupted pathways 55 of the first set of optical detection pathways 15, a second pair of outermost interrupted pathways 60 of the second set of optical detection pathways 20. The normal function code of controller device 22 may have code for determining a pair of minimum and maximum coordinates, such as either one of (Xₘᵢₙ, Yₘᵢₙ) and (Xₘₐₓ, Yₘₐₓ), or of (Xₘᵢₙ, Yₘₐₓ) and (Xₘₐₓ, Yₘᵢₙ), which are formed at intersections 35 of the first pair of outermost interrupted pathways 15 and the second pair of outermost interrupted pathways 20. In an embodiment, code is provided to report the pair of minimum and maximum coordinates to the computer. The pair of minimum and maximum coordinates corresponds to a blocked area 65 formed on input area 10.

In one embodiment, a switch may be provided to selectively change controller device 22 between the diagnostic mode and the normal function mode. In another embodiment, code is provided to selectively change controller device 22 between the diagnostic mode and the normal function mode. In one embodiment, a user input is provided to selectively change the controller device 22 between the diagnostic mode and the normal function mode. In another embodiment, the code to selectively change controller device 22 between the diagnostic mode and the normal function mode is automated.

In an embodiment, angle α between the first set of optical pathways 15 and the second set of optical pathways 20 is about 90°.

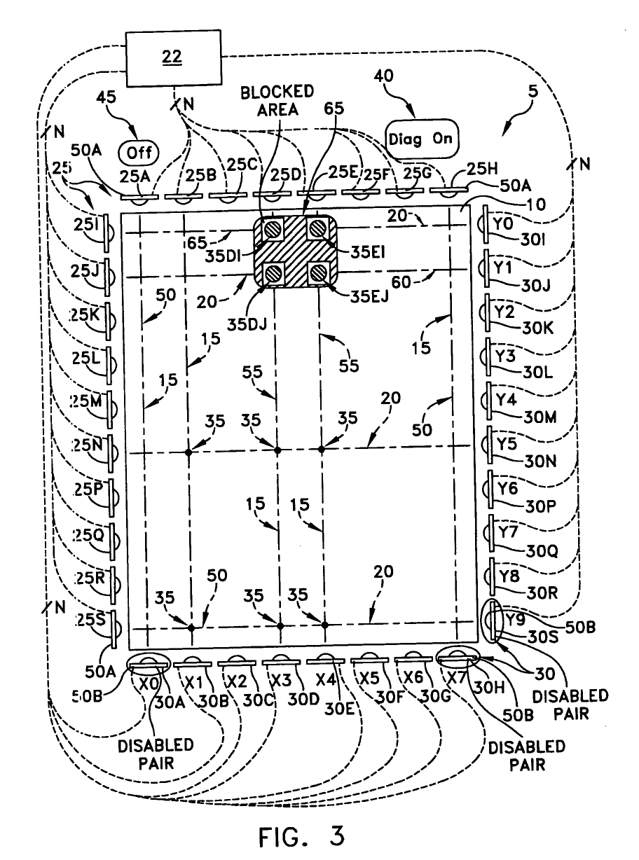

In one embodiment, the pair of minimum and maximum coordinates formed at the intersections of the first pair of outermost interrupted pathways 15 and the second pair of outermost interrupted pathways 20 may comprise a first coordinate of a minimum value of the first set of optical detection pathways 15 and a minimum value of the second set of optical detection pathways 20, i.e., (X3,Y0) as shown as location 35DI in FIG. 3, and a second coordinate comprises a maximum value of the first set of optical detection pathways 15 and a maximum value of the second set of optical detection pathways 20, i.e., (X4,Y1) as shown as location 35EJ in FIG. 3.

In an embodiment, the pair of minimum and maximum coordinates formed at the intersections of the first pair of outermost interrupted pathways 15 and the second pair of outermost interrupted pathways 20 comprise a first coordinate of a minimum value of the first set of optical detection pathways 15 and a maximum value of the second set of optical detection pathways 20, i.e., (X3,Y1) as shown as location 35DJ in FIG. 3, and a second coordinate comprises a maximum value of the first set of optical detection pathways 15 and a minimum value of the second set of optical detection pathways 20, i.e., (X4,Y0) as shown as location 35EI in FIG. 3.

In one embodiment, the diagnostic mode may include code for interrogating the first set of optical detection pathways 15 and the second set of optical pathways 20. In an embodiment, the diagnostic mode of the controller device may include code for receiving indications from the optical input area 10 corresponding to the interrupted pathways of the first set of optical detection pathways 15 and the interrupted pathways of the second set of optical detection pathways 20. In one embodiment, the normal function mode may include code for interrogating the first set of optical detection pathways 15 and the second set of optical pathways 20. In an embodiment, the normal function mode may include code for receiving indications from optical input area 10 corresponding to the interrupted pathways of the first set of optical detection pathways 15 and interrupted pathways of the second set of optical pathways 20.

In an embodiment, system 5 may include a controller device 22 with the diagnostic mode having code for interrogating the first set of optical detection pathways 15 and the second set of optical pathways 20. For the diagnostic mode, controller device 22 may include code for receiving for assigning a status of faulty pathway to each one of the interrupted pathways of the first set of optical detection pathways and to each one of the interrupted pathways of the second set of optical detection pathways from optical input area 10 corresponding to the interrupted pathways of the first set of optical detection pathways 15 and interrupted pathways of the second set of optical pathways 20. Controller device 22, for the diagnostic mode, may include code for assigning a status of faulty pathway to each one of the interrupted pathways of the first set of optical detection pathways 15 and to each one of the interrupted pathways of the second set of optical detection pathways 20.

In one embodiment, system 5 may include controller device 22 with the normal function mode having code for interrogating the first set of optical detection pathways 15 and the second set of optical pathways 20. For the normal function mode, controller device 22 may include code for receiving indications from optical input area 10 corresponding to the interrupted pathways of the first set of optical detection pathways 15 and interrupted pathways of the second set of optical pathways 20. Controller device 22, for the normal function mode, may include code for excluding each one of the interrupted pathways having the status of faulty pathway and determining a first pair of outermost interrupted pathways of the first set of optical detection pathways 15 and a second pair of outermost interrupted pathways of the second set of optical detection pathways 20. For the normal function mode, controller device 22 may include code for determining a pair of minimum and maximum coordinates formed at intersections of the first pair of outermost interrupted pathways and the second pair of outermost interrupted pathways. Controller device 22, for the normal function mode, may include code for reporting the pair of minimum and maximum coordinates to the computer. The pair of minimum and maximum coordinates corresponds to a blocked area 65 formed on the optical input area 10.

In an embodiment, system 5 detects problems with optical input area 10 and recovers at least a substantial portion of the functionality of optical input area 10 when only a relatively small number of pairs of emitters 25 and detectors 30 are not properly working. System 5 in effect lengthens the lifetime and increases the reliability of the optical input area 10.

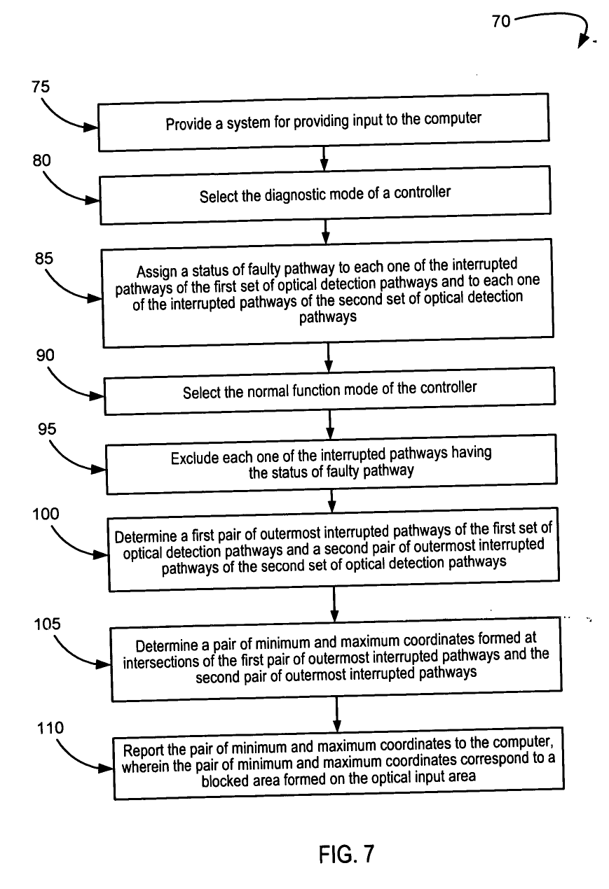

Referring to FIG. 7, and in an embodiment, a method 70 for providing input to a computer may include providing 75 a system 5 for providing input to the computer. One step may include selecting 80 the diagnostic mode of controller device 22. Another step may include assigning 85 a status of faulty pathway 50 to each one of the interrupted pathways of the first set of optical detection pathways 15 and to each one of the interrupted pathways of the second set of optical detection pathways 20. Subsequently, a step may include selecting 90 the normal function mode of controller device 22. A step may include excluding 95 each one of the interrupted pathways having the status of faulty pathway 50. Another step may include determining 100 a first pair of outermost interrupted pathways of the first set of optical detection pathways 55 and a second pair of outermost interrupted pathways of the second set of optical detection pathways 60. A step may include determining 105 a pair of minimum and maximum coordinates 35 formed at intersections 35 of the first pair of outermost interrupted pathways 55 and the second pair of outermost interrupted pathways 55. Another step may include reporting 110 the pair of minimum and maximum coordinates 35 to the computer, wherein the pair of minimum and maximum coordinates 35 corresponds to a blocked area formed on optical input area 10.

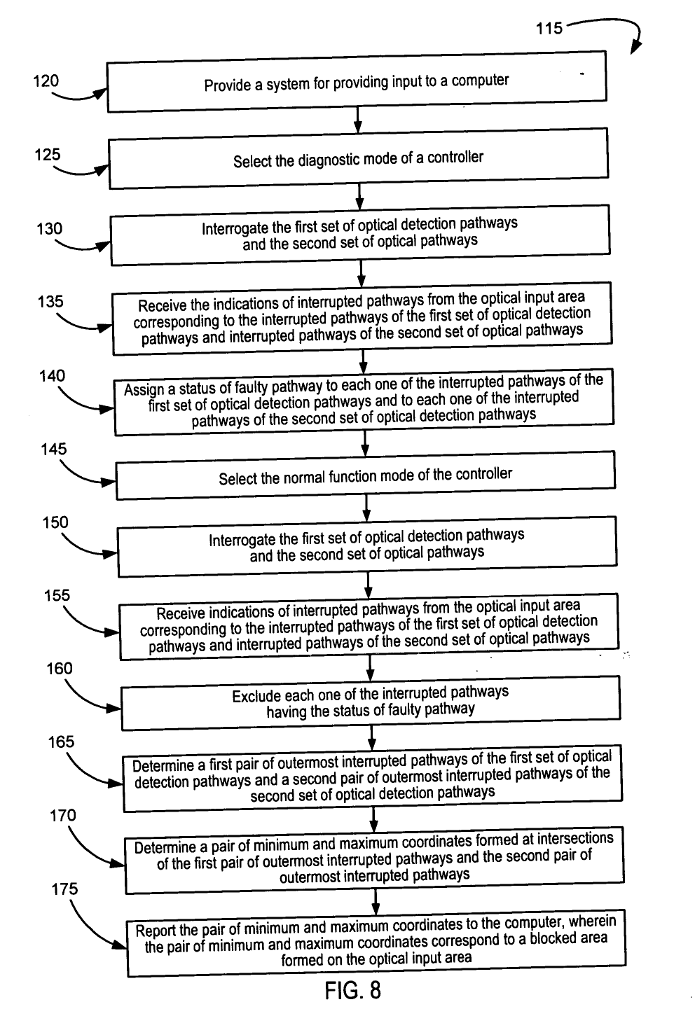

Referring to FIG. 8, and in an embodiment, a method 115 for providing input to a computer may include providing 120 a system 5 for providing input to a computer. One step may include selecting 125 the diagnostic mode of controller device 22. Another step may include interrogating 130 the first set of optical detection pathways and the second set of optical pathways. A step may include receiving 135 indications from the optical input area 10 corresponding to the interrupted pathways of the first set of optical detection pathways and interrupted pathways of the second set of optical pathways. One step may include assigning 140 a status of faulty pathway to each one of the interrupted pathways of the first set of optical detection pathways and to each one of the interrupted pathways of the second set of optical detection pathways. Another step may include selecting 145 the normal function mode of controller device 22. A step may include interrogating 150 the first set of optical detection pathways and the second set of optical pathways. A step may include receiving 155 indications from the optical input area 10 corresponding to the interrupted pathways of the first set of optical detection pathways and interrupted pathways of the second set of optical pathways. Another step may include excluding 160 each one of the interrupted pathways having the status of faulty pathway. A step may include determining 165 a first pair of outermost interrupted pathways of the first set of optical detection pathways and a second pair of outermost interrupted pathways of the second set of optical detection pathways. A step may include determining 170 a pair of minimum and maximum coordinates formed at intersections of the first pair of outermost interrupted pathways and the second pair of outermost interrupted pathways. Another step may include reporting 175 the pair of minimum and maximum coordinates to the computer, wherein the pair of minimum and maximum coordinates correspond to a blocked area formed on the optical input area.

In an embodiment, the controller device 22 of optical input area 10 may be programmed to alternatively operate in one of two modes. These modes include the diagnostic mode, which may be identified with indicator 40, and normal function mode, which may be identified with indicator 45.

In an embodiment, the data reporting format for each one of the two modes may differ from one another. In the normal function mode, system 5 reports only two coordinates. These are (Xₘᵢₙ, Yₘᵢₙ) and (Xₘₐₓ, Yₘₐₓ). In FIG. 3, the normal function mode reports coordinates (X3, Y0) and (X4, Y1) for blocked area 65. Coordinates (X3, Y0) and (X4, Y1) are illustrated as locations 35DI and 35EJ, respectively, on the optical input area 10 shown in FIG. 3.

In the diagnostic mode, system 5 reports only the individual pairs of emitters 25 and receivers 30. These individual pairs of emitters 25 and 30 may be reported as one or more faulty pathway 50, which may be identified as X0-X7 and Y0-Y9 as shown in FIGS. 1-6. In FIG. 1, faulty pathways 50 include X0, X7 and Y9. In the diagnostic mode, the faulty pathways may be identified and then excluded in the normal function mode.

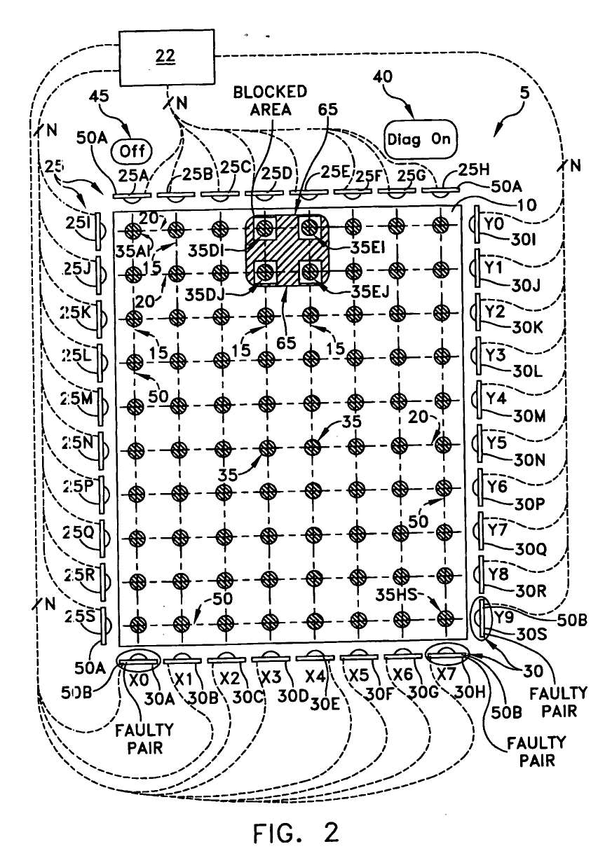

Referring to FIGS. 1-3, and in an example, there is shown optical input area 10 having blocked area 65. In FIG. 1, controller device is in the normal function mode as indicator 45 displays “On” and indicator 40 displays (Diag Off). In this example, pathways X0, X7 and Y9 each have at least one of a faulty optical emitter 50A or a faulty optical detector 50B. Faulty optical emitter 50A or faulty optical detector 50B result in a faulty pathway 50 (FIG. 2).

Referring to FIG. 2, there is shown faulty pathways 50 at pathways X0, X7 and Y9. Faulty pairs of optical emitters 25 and optical detectors 30 may be detected by switching controller device 22 to the diagnostic mode, which is shown by indicator 45. Controller device 22 reports pathways X0, X7 and Y9 paths as faulty pathways 50.

If detection of the faulty pathways 50 is not undertaken prior to operation in the normal function mode, controller device 22 will report faulty coordinates (X0, Y0) and (X7, Y9), which correspond to (Xₘᵢₙ, Yₘᵢₙ) and (Xₘₐₓ, Yₘₐₓ). These faulty coordinates (X0, Y0) and (X7, Y9) are illustrated as locations 35AI and 35HS, respectively, on the optical input area 10 as shown in FIG. 2. In addition, black dots 35 shown in FIG. 2 are the coordinates that detected by controller device 22. If no action taken, optical input area 10 can be considered as faulty and not functioning. Without the diagnostic function mode, optical input area 10 would generally need to be replaced with new panel.

In an embodiment, controller device 22 is set to the diagnostics mode and detects faulty pairs of optical emitters 25 and optical detectors 30, which are identified as faulty optical emitters 50A and faulty optical emitters 50B.

Optionally, after detection of faulty optical emitters 50A and faulty optical emitters 50B, power is increased to faulty optical emitters 50A. If a pair of faulty optical emitters 50A and faulty optical emitters 50B is still faulty, controller device 22 may disable each of the faulty pathways 50.

Looking at FIG. 3, there is shown a set of recovered coordinates at blocked area 65. These recovered coordinates allow controller device 22 to report (X3, Y0) and (X4, Y1) for blocked area 65. In an embodiment, controller device 22 is set back to normal function mode so as to obtain these recovered coordinates from optical input area 10 and report these recovered coordinates to the computer.

Referring now to FIGS. 4-6, and in an example, there is shown optical input area 10 having blocked area 65A. In FIG. 4, there is shown fault path 50 on pathway X4.

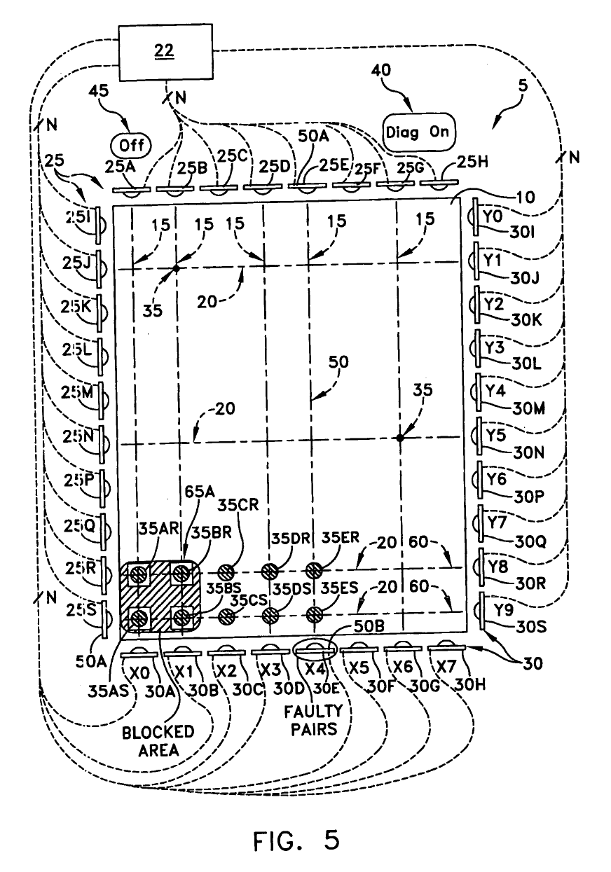

Referring to FIG. 5, there is shown the faulty X4 pathway causing erroneous detection of maximum coordinates through minimum coordinates (X0, Y8) through (X4, Y9), which correspond to location 35AR through location 35ES, respectively.

Still looking at FIG. 5, controller device 22 of optical input area 10 searches for Xₘᵢₙ, Xₘₐₓ, Yₘᵢₙ and Yₘₐₓ. Since the pathway X4 is faulty, the Xₘₐₓ is always X4. Although X2, X3 and X4 paths are not blocked, the faulty pathway 50 between emitter 25E and detector 30E along pathway X4 confuses controller device 22 to report the false Xₘₐₓ of X4.

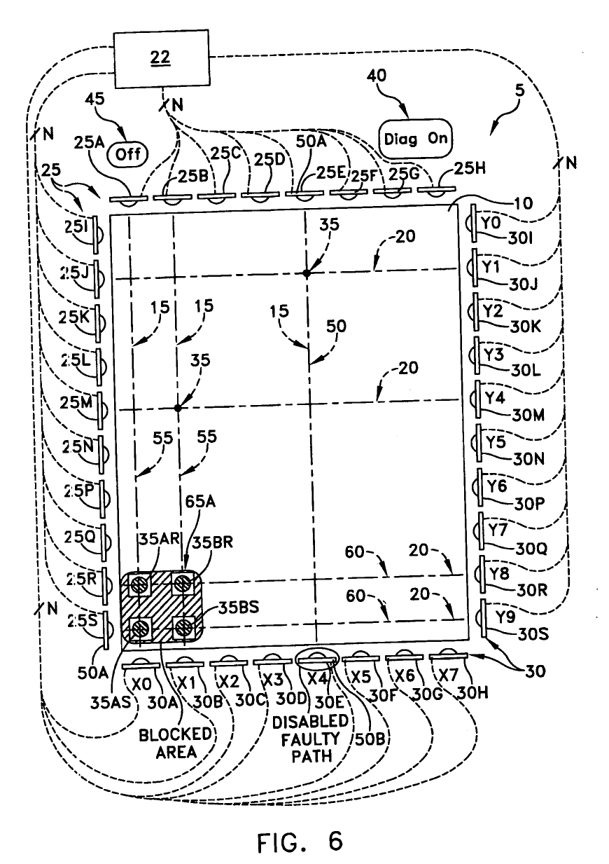

Referring to FIG. 6, there is shown a set of recovered coordinates from (X0, Y8) and (X1, Y9), which correspond to location 35AR and location 35BS, respectively, after controller device 22 has disabled faulty pathway 50 along the pathway X4.

In an embodiment, the diagnostic mode is used for fault recovery at the boot up or restart of system 5. If one or more of the LEDs of emitters 25A-25S is blocked by dirt, system 5 will probably malfunction. A simple restart of system 5 activates the diagnostic mode prior to invoking the normal operating mode. When the dirt is removed and after a restart, no faulty pathways will be detected when the diagnostic mode is invoked by controller device 22. As no faulty pathways are present after this iteration of the diagnostic mode, controller device 22 is cleared of faulty pathways and, in the normal function mode, the previous faulty pathways are included in the determination of the minimum and maximum coordinates representing the blocked area. Generally, this system will account for other malfunctions of the optical input area which cause faulty pathways, such grease and faulty LEDs.

What is claimed is:

1. A system for providing input to a computer, the system comprising:
an optical input area having a first set of optical detection pathways and a second set of optical detection pathways, and the first set of optical detection pathways and the second set of optical detection pathways positioned at an angle with respect to one another so as to provide a plurality of intersecting locations;
a controller device in communication with the optical input area and the computer, the controller having a diagnostic function mode and a normal mode, the controller device receiving indications of interrupted pathways from optical input area corresponding to interrupted pathways of the first set of optical detection pathways and interrupted pathways of the second set of optical pathways;
the diagnostic mode of the controller having code for assigning a status of faulty pathway to each one of the interrupted pathways of the first set of optical detection pathways and to each one of the interrupted pathways of the second set of optical detection pathways; and
the normal function mode of the controller having code for excluding each one of the interrupted pathways having the status of faulty pathway and determining a first pair of outermost interrupted pathways of the first set of optical detection pathways, a second pair of outermost interrupted pathways of the second set of optical detection pathways, and a pair of minimum and maximum coordinates formed at intersections of the first pair of outermost interrupted pathways and the second pair of outermost interrupted pathways, wherein the pair of minimum and maximum coordinates correspond to a blocked area formed on the optical input area.

2. The system in accordance with claim 1, wherein the optical input area comprises an optical touch screen.

3. The system in accordance with claim 1, wherein the optical input area comprises an input pad.

4. The system in accordance with claim 3, wherein the input pad comprises markings thereon.

5. The system in accordance with claim 3, wherein the input pad comprises a blank background.

6. The system in accordance with claim 1, wherein the optical input area comprises an opening without a screen or pad associated therewith.

7. The system in accordance with claim 1, further comprising a switch to selectively change the controller device between the diagnostic mode and the normal function mode.

8. The system in accordance with claim 1, further comprising code to selectively change the controller device between the diagnostic mode and the normal function mode.

9. The system in accordance with claim 8, wherein the code to selectively change the controller device between the diagnostic mode and the normal function mode is automated.

10. The system in accordance with claim 1, further comprising a user input to selectively change the controller device between the diagnostic mode and the normal function mode.

11. The system in accordance with claim 1, wherein the angle is about 90° with respect to the first set of optical pathways and the second set of optical pathways.

12. The system in accordance with claim 1, further comprising a set of coordinates formed at intersecting locations of the first set of optical detection pathways and the second set of optical detection pathways, wherein the pair of minimum and maximum coordinates formed at the intersections of the first pair of outermost interrupted pathways and the second pair of outermost interrupted pathways comprise a first coordinate of a minimum value of the first set of optical detection pathways and a minimum value of the second set of optical detection pathways, and a second coordinate comprises a maximum value of the first set of optical detection pathways and a maximum value of the second set of optical detection pathways.

13. The system in accordance with claim 1, further comprising a set of coordinates formed at intersecting locations of the first set of optical detection pathways and the second set of optical detection pathways, wherein the pair of minimum and maximum coordinates formed at the intersections of the first pair of outermost interrupted pathways and the second pair of outermost interrupted pathways comprise a first coordinate of a minimum value of the first set of optical detection pathways and a maximum value of the second set of optical detection pathways, and a second coordinate comprises a maximum value of the first set of optical detection pathways and a minimum value of the second set of optical detection pathways.

14. The system in accordance with claim 1, wherein the diagnostic mode further comprises code for interrogating the first set of optical detection pathways and the second set of optical pathways.

15. The system in accordance with claim 1, wherein the diagnostic mode of the controller device further comprises code for receiving indications from the optical input area corresponding to the interrupted pathways of the first set of optical detection pathways and the interrupted pathways of the second set of optical detection pathways.

16. The system in accordance with claim 1, wherein the normal function mode further comprises code for interrogating the first set of optical detection pathways and the second set of optical pathways.

17. The system in accordance with claim 1, wherein the normal function mode further comprises code for receiving indications from the optical input area corresponding to the interrupted pathways of the first set of optical detection pathways and interrupted pathways of the second set of optical pathways.

18. The system in accordance with claim 1, wherein the diagnostic mode is invoked by at least one of boot up and restart of system.

19. The system in accordance with claim 1, further comprising a set of coordinates formed at intersecting locations of the first set of optical detection pathways and the second set of optical detection pathways;
wherein the diagnostic mode of the controller comprises (i) code for interrogating the first set of optical detection pathways and the second set of optical pathways, (ii) code for receiving indications from the optical input area corresponding to the interrupted pathways of the first set of optical detection pathways and interrupted pathways of the second set of optical pathways, and (iii) code for assigning a status of faulty pathway to each one of the interrupted pathways of the first set of optical detection pathways and to each one of the interrupted pathways of the second set of optical detection pathways; and
the normal function mode of the controller comprises (i) code for interrogating the first set of optical detection pathways and the second set of optical pathways, (ii) code for receiving indications from the optical input area corresponding to the interrupted pathways of the first set of optical detection pathways and interrupted pathways of the second set of optical pathways, (iii) code for excluding each one of the interrupted pathways having the status of faulty pathway and determining a first pair of outermost interrupted pathways of the first set of optical detection pathways, a second pair of outermost interrupted pathways of the second set of optical detection pathways, and a pair of minimum and maximum coordinates formed at intersections of the first pair of outermost interrupted pathways and the second pair of outermost interrupted pathways, and (iv) code for reporting the pair of minimum and maximum coordinates to the computer, wherein the pair of minimum and maximum coordinates correspond to a blocked area formed on the optical input area.

20. A method for providing input to a computer, the method comprising:
providing a system for providing input to the computer, the system comprising:
an optical input area having a first set of optical detection pathways and a second set of optical detection pathways, the first set of optical detection pathways and the second set of optical detection pathways positioned at an angle with respect to one another so as to provide a plurality of intersecting locations; and
a controller device in communication with the optical input area and the computer, the controller having a diagnostic function mode and a normal mode, and the controller device receiving indications of interrupted pathways from optical input area corresponding to interrupted pathways of the first set of optical detection pathways and interrupted pathways of the second set of optical pathways;
selecting the diagnostic mode of the controller, and then:
assigning a status of faulty pathway to each one of the interrupted pathways of the first set of optical detection pathways and to each one of the interrupted pathways of the second set of optical detection pathways;
selecting the normal function mode of the controller, and then:
(i) excluding each one of the interrupted pathways having the status of faulty pathway;
(ii) determining a first pair of outermost interrupted pathways of the first set of optical detection pathways and a second pair of outermost interrupted pathways of the second set of optical detection pathways;
(iii) determining a pair of minimum and maximum coordinates formed at intersections of the first pair of outermost interrupted pathways and the second pair of outermost interrupted pathways; and
(iv) reporting the pair of minimum and maximum coordinates to the computer, wherein the pair of minimum and maximum coordinates correspond to a blocked area formed on the optical input area.

21. A method for providing input to a computer in accordance with claim 20, the method further comprising:
interrogating the first set of optical detection pathways and the second set of optical pathways after selecting the diagnostic mode of the controller, and then:
receiving indications of interrupted pathways from optical input area corresponding to interrupted pathways of the first set of optical detection pathways and interrupted pathways of the second set of optical pathways prior to assigning a status of faulty pathway to each one of the interrupted pathways of the first set of optical detection pathways and to each one of the interrupted pathways of the second set of optical detection pathways.
